(19) United States
(12) Patent Application Publication
(10) Pub. No.: US 2003/0147624 A1
(43) Pub. Date: Aug. 7, 2003

(54) Method and apparatus for controlling a media player based on a non-user event

(75) Inventors: Miroslav Trajkovic, Ossining, NY (US); Srinivas Gutta, Yorktown Heights, NY (US); Antonio J. Colmenarez, Maracaibo (VE)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/071,393

(22) Filed: Feb. 6, 2002

(51) Int. Cl. H04N 5/76; H04N 7/00; H04N 7/18; H04N 9/47

(52) U.S. Cl. 386/46; 348/143

(57) ABSTRACT

A media player controller is disclosed that monitors non-user event and automatically controls a media player in response to predefined events. The media player controller includes an information capture device that obtains input information from the non-user. The input information is processed by the media player controller to identify one or more predefined non-user events. A number of rules can be utilized to define various non-user events, such as when the non-user is in the vicinity of the media player. Each rule contains a condition and a corresponding action-item that should be performed when the condition is satisfied.

### FIELD OF INVENTION

The present invention relates to methods and apparatus for controlling a media player and, more particularly, for automatically controlling a media player based on a non-user event.

### BACKGROUND OF THE INVENTION

Each year, an ever-growing number of consumers owns, or at least utilizes, electronic devices such as televisions, personal computers, and stereo systems. It often happens that people visit web pages or document pages on their computer, watch TV programs, or listen to radio stations that they do not want others to see or hear. The user may not want another person entering the vicinity of the device to observe or hear the output of the user's device. Also, when viewing or listening to such a device, the user is often called away from or leaves the device for a brief or extended period of time. During this time, the user has no control over the setting of the device if someone enters the area of the device.

For example, it is a common situation that one changes the currently active window displayed on their computer monitor when another person enters the office. Another situation is that a person watching a particular movie on television or listening to a particular radio program may not want minors to see or hear the material.

While remote controls and other additional features have greatly improved the convenience of such electronic devices, they are static. In other words, the settings are fixed until a different setting is affirmatively chosen by the user.

There is currently no mechanism that will regulate or change the settings of the device based upon a non-user event. A need therefore exists for a media player controller that monitors non-user events and automatically adjusts a media player in response to predefined events.

### SUMMARY OF THE INVENTION

Generally, a method and apparatus are provided for automatically controlling a media player in response to predefined non-user events.

According to one aspect of the invention, a media player controller includes an information capture device adapted for imaging of non-user events. The input information obtained by the information capture device is processed by the media player controller to identify one or more predefined events. The media controller then adjusts one or more settings of the media player based at least in part on the identified events.

According to another aspect of the invention, a rule defines a non-user event and a response. The rule contains one or more conditions and a corresponding action item that should be performed by the media player controller when the condition is satisfied to adjust one or more settings of the media player.

A more complete understanding of the present invention, as well as further features and advantages of the present invention, will be obtained by reference to the following detailed description and drawings.

### BRIEF DESCRIPTION OF THE DRAWINGS

FIG. 1 illustrates a processing system that includes media player controller in accordance with the present invention;

FIG. 2 illustrates a sample table from the event database of FIG. 1; and

FIG. 3 is a flow chart of an exemplary user event monitoring process embodying principles of the present invention.

### DETAILED DESCRIPTION

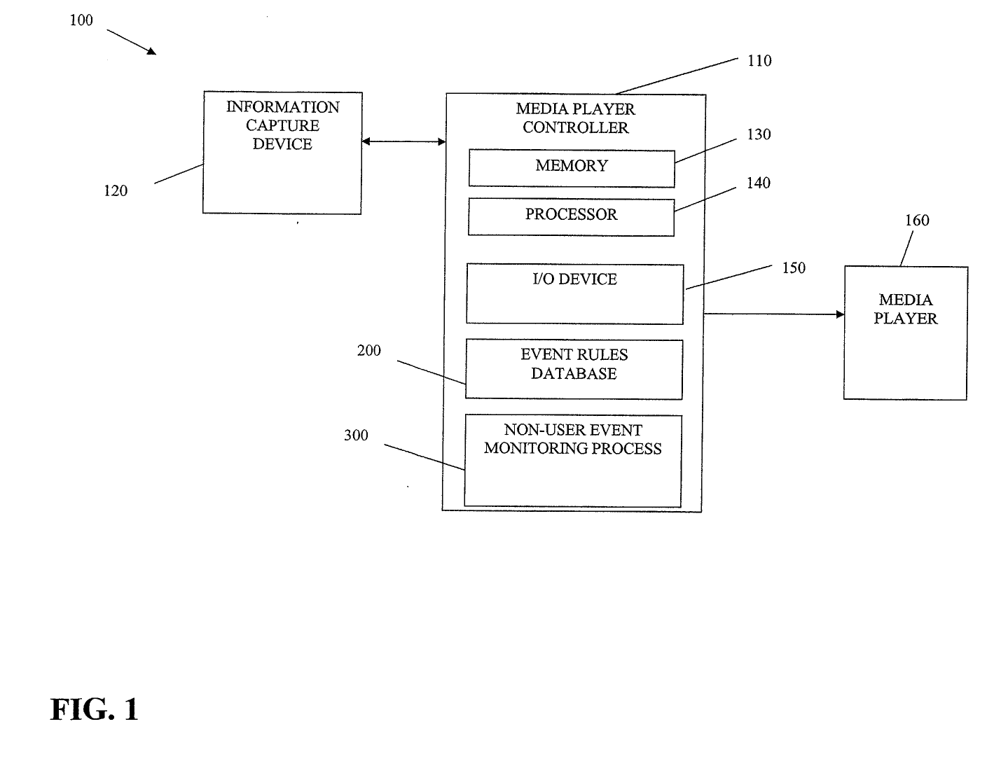

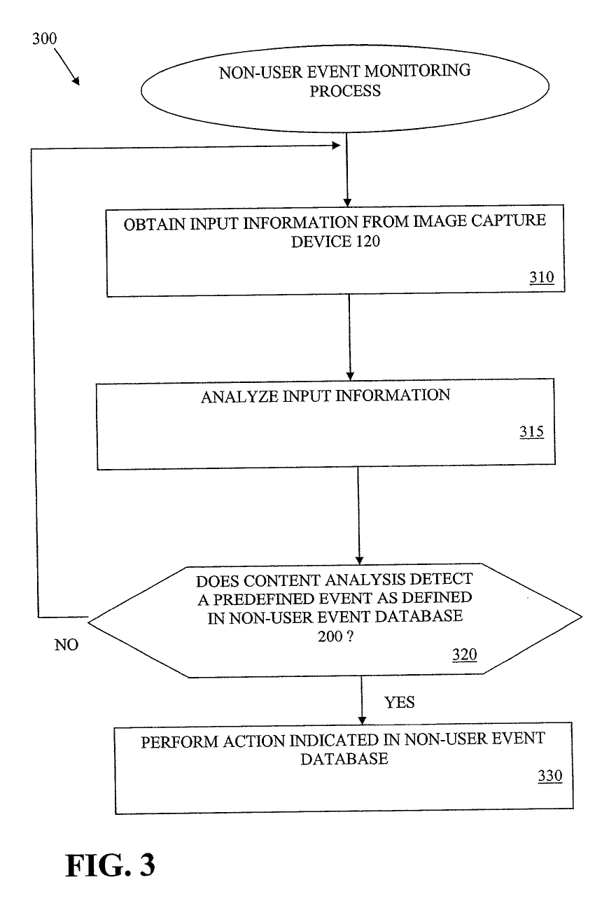

FIG. 1 illustrates a system 100 for controlling a media player in accordance with the present invention. The system 100 includes a media player controller 110, an information capture device 120, and a media player 160. The information obtained by the information capture device 120 is processed by the media player controller 110 in a manner described below in conjunction with FIG. 3 to identify one or more predefined non-user activities or other events.

Non-user as defined herein is any person other than the person in control of the media player. For example, non-user could be any person entering a room in which the media player and user are located.

The media player 160 may be any media player device known in the art, such as a television, computer, radio/stereo, DVD player, CD player, VCR, and the like, as well as portions or combinations of these and other devices.

The information capture device 120 can be any device that can obtain information regarding the presence or identity of a non-user. For example, information capture device 120 can include a motion detector, biometrics sensor, a camera or other visual capture device, or an audio capture device such as a microphone, as well as combinations or portions of these and other types of information capture devices.

The media content controller 110 includes a memory 130 and a processor 140. The term processor as used herein is intended to include a microprocessor, digital signal processor (DSP), central processing unit (CPU), or any other data processing element that may utilized in a given data processing device. Additionally, it is to be understood that the term processor may refer to more than one processing device, and that various elements associated with a processing device may be shared by other processing devices. In addition, it should be noted that the memory 120 may represent an electronic memory, an optical or magnetic disk-based memory, a tape-based memory, as well as combinations or portions of these and other types of storage devices.

The media player controller 110 can also include an input/output device 150. The term “input/output device” or “I/O device” as used herein is intended to include, for example, devices to interface with the information capture device 120 and media player 160. The I/O device 150 can also include one or more input devices (e.g., keyboard, mouse, etc.) for entering data to the processor and/or altering the event rules database 200.

The media player controller 110 may be embodied as any computing device, such as a personal computer or workstation containing a processor 140, such as a central processing unit CPU, and memory 130, such as RAM and/or ROM. Alternatively, the media player controller 110 may be embodied as an application specific integrated circuit (ASIC) that is included, for example, in a television, settop terminal or another electronic device.

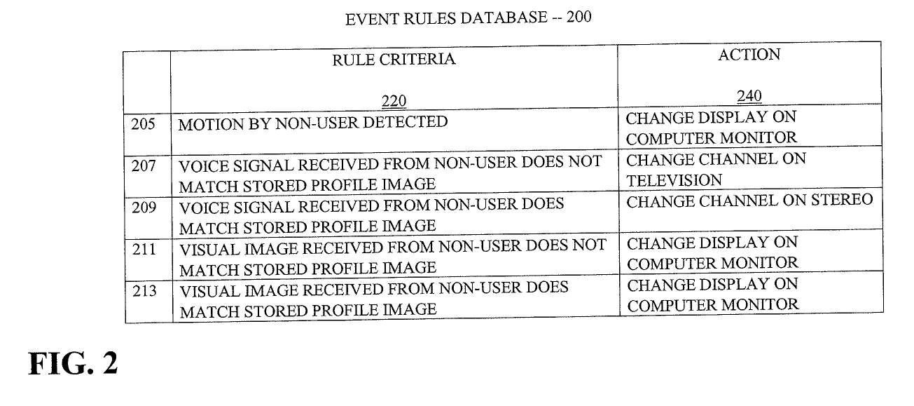

In one implementation, the present invention employs an event rules database 200, as described further in conjunction with FIG. 2, that records event rules. The event rules define various events that initiate an adjustment of one or more settings of the media player 160. The event rules database may be stored in the associated memory 130 and, when ready to be utilized, loaded in whole or in part and executed by the processor 140.

The non-user events defined by each rule may be detected by the media player controller 110 in accordance with the present invention. As described further below, each rule contains one or more criteria that must be satisfied in order for the rule to be triggered, and, optionally, a corresponding action item that should be performed by the media player controller 110 to adjust one or more settings of the media player 160 when the predefined criteria for initiating the rule is satisfied. At least one of the criteria for each rule is a condition detected in the information obtained by the information capture device 120 in accordance with the present invention.

Upon detection of such a predefined non-user event, the corresponding action, if any, is performed by the media player controller 110. Typically, the corresponding action is the issuance of a command to the media player 160 to adjust one or more settings. The commands can include, for example, change program channel, change display, mute, record, volume adjust, power save mode, live pause, and power off.

As shown in FIG. 1 and described further below in conjunction with FIG. 3, the media player controller 110 also contains a non-user event monitoring process 300. Generally, the non-user event monitoring process 300 processes the information or images obtained from the information capture device 120 and detects one or more events defined in the event rules database 200.

In one embodiment, the information capture device 120 captures an input image for use in the media player controller 110. The input image obtained by the information capture device is processed by the media player controller 110 according to the event rules database 200 to determine what change, if any, to make to the settings of the media player 160.

The invention can also employ profile information stored, for example, in the memory 130. As described above with regard to the input information, the profile information can be visual, audio, or any other form of information that can be utilized in detecting the presence of an individual or recognizing a particular individual. After the input information is obtained by the information capture device 120, the input information can be compared to the stored profile information as part of the non-user event monitoring process 300. The media player controller 110 can than take action or not take action in accordance with the event rules database 200.

FIG. 2 illustrates an exemplary table of the event rules database 200 that records each of the rules that define various non-user events. Each rule in the event rules database 200 includes predefined criteria specifying the conditions under which the rule should be initiated, and, optionally, a corresponding action item that should be triggered when the criteria associated with the rule is satisfied. Typically, the action item defines one or more adjustments to the settings of the media player 160 that should be performed when the rule is triggered.

As shown in FIG. 2, the exemplary event rules database 200 maintains a plurality of records, such as records 205-213, each associated with a different rule. For each rule, the event rules database 200 identifies the rule criteria in field 220 and the corresponding action item, if any, in field 240.

For example, the information capture device 120 may include a motion sensor that is located at or near a doorway to an office. In this situation, the condition satisfied in the rule criteria 220 may simply be the detection of motion of a non-user near that doorway, i.e. the condition associated with rule 205. The corresponding action 240 may then be to change the display on a computer monitor, e.g. to a preselected page such as the desktop.

In another example, a voice capture device may be positioned near a television set. The condition satisfied in the rule criteria 220 may then be a voice signal received from a non-user. In this situation, the controller 110 can compare the input voice signal with a stored profile voice image. If the input voice signal does not match any of the stored profile voice signals, i.e., the condition associated with rule 207, the corresponding action 240 may be to change the channel on a television display. This scenario could occur, for example, if a minor walked into a room while a television channel was selected to view a violent movie. When the child's voice is detected within the vicinity of the television, the media player controller 110 can compare the voice to stored profile voice signals of the adults living in the household. When the child's voice does not match any of the stored profile signals from the adults, the television channel will then be changed, preferably to a channel that airs material suitable for children. Alternatively, the television could simply turn off.

In another example, the same scenario as above could arise, except the voices of the children living in the household can be stored as profile voice signals instead of the adults' voices. An adult may not want the child to hear inappropriate material aired on a particular radio station. When the child's voice is detected, the controller 110 can compare the voice to those stored and search for a positive match, i.e. the condition associated with rule 209. If the controller 110 detects a positive match for a child's voice stored as a voice signal, the controller can change the channel of the radio.

In another example, the input information may be an input image from a visual capture device. The condition satisfied in the rule criteria 220 may then be a visual image received of a non-user. In this situation, the controller 110 can compare the input visual image with a stored profile visual image of the user. If the input visual image does not match any of the stored profile visual images, i.e., the condition associated with rule 211, the corresponding action may be to change the display on the computer screen.

Alternatively, in the scenario set forth above, profile visual images of particular non-users may be stored. When receiving an input visual image, the media player controller 110 can compare the input image to those stored and search for a positive match. Thus, the condition satisfied in the rule criteria 220 can be a positive match of a non-user, i.e., the condition associated with rule 213, and the corresponding action can be to change the display on a computer screen.

FIG. 3 is a flow chart describing an exemplary non-user event monitoring process 300. The non-user event monitoring process 300 processes input information obtained from the information capture device 120 and detects one or more events defined in the event rules database 200. The exemplary non-user event monitoring process 300 is a general process illustrating the broad concepts of the present invention.

As shown in FIG. 3, the non-user event monitoring process 300 initially obtains one or more inputs from the information capture device 120 during step 310. Thereafter, the input information is analyzed during step 315. The type of analysis will depend upon the type of input information received. For example, if the input information is an audio signal or visual input image, the non-user event monitoring process 300 can analyze the audio or visual input information during step 315 using well-known conventional audio and/or video content analysis techniques. If the input information is not an audio signal or visual image, such as a positive signal from a motion detector, analysis based on audio or video content analysis will not be necessary.

For a detailed discussion of suitable audio content analysis techniques, see, for example, Silvia Pfeiffer et al., “Automatic Audio Content Analysis,” Proc. ACM Multimedia 96, 21-30, Boston, Mass. (November 1996), which is incorporated by reference herein. For a detailed discussion of suitable video content analysis techniques, see, for example, Nathanael Rota and Monique Thonnat, “Video Sequence Interpretation for Visual Surveillance,” Proc. of the 3d IEEE Int'l Workshop on Visual Surveillance, 59-67, Dublin, Ireland (Jul. 1, 2000), and Jonathan Owens and Andrew Hunter, “Application of the Self-Organizing Map to Trajectory Classification,” Proc. of the 3d IEEE Int'l Workshop on Visual Surveillance, 77-83, Dublin, Ireland (Jul. 1, 2000), both of which are incorporated by reference herein. Generally, the audio content analysis and VCA techniques are employed to recognize various features in the signals obtained by the information capture device 120.

A test is performed during step 320 to determine if the analysis of the input information in step 315 detects a predefined event, as defined in the event rules database 200. If it is determined during step 320 that a predefined event is not detected, then program control returns to step 310 to continue monitoring user activities in the manner described above. If, however, it is determined during step 320 that a predefined event is detected, then the event is processed during step 330 as indicated in action field 240 of the event rules database 200.

The invention can also be implemented at least in part in the form of one or more software programs which are stored on an electronic, magnetic or optical storage medium and executed by a processing device, e.g., by the processor 140 or system.

The system 100 shown in FIG. 1, event rules database 200 shown in FIG. 2, and the non-user event monitoring process 300 shown in FIG. 3, are by way of example only, and other arrangements of elements can be used. It is to be understood that the embodiments and variations shown and described herein are merely illustrative of the principles of this invention and that various modifications may be implemented by those skilled in the art without departing from the scope and spirit of the invention.

What is claimed is:

1. A method for controlling a media player, comprising:
determining at least one rule defining a predefined non-user event, said rule including at least one condition and an action item to be performed to automatically adjust said media player when said condition is satisfied;
analyzing input information characterizing a non-user event to identify said condition; and
performing said action item if said condition is satisfied.

2. The method of claim 1, wherein said input information is generated by an information capture device.

3. The method of claim 2, wherein said information capture device comprises at least one of a motion detector, biometrics sensor, visual capture device, or an audio capture device.

4. The method of claim 1, wherein said non-user event comprises a non-user appearing in the vicinity of said media player.

5. The method of claim 1, wherein said condition comprises detection of motion by said non-user.

6. The method of claim 1, wherein said condition comprises a voice signal, associated with a non-user, that does not match a stored profile voice signal.

7. The method of claim 1, wherein said condition comprises a voice signal, associated with a non-user, that does match a stored profile voice signal.

8. The method of claim 1, wherein said condition comprises a visual image, associated with a non-user, that does not match a stored profile image.

9. The method of claim 1, wherein said condition comprises a visual image, associated with a non-user, that does match a stored profile image.

10. The method of claim 1, wherein said media player comprises a computer.

11. The method of claim 10, wherein said action item comprises changing a display of said computer.

12. The method of claim 1, wherein said media player comprises a television.

13. The method of claim 12, wherein said action item comprises changing a program channel of said television.

14. An apparatus for controlling a media player, comprising:
a memory for storing computer readable code; and
a processor operatively coupled to said memory, said processor configured to:
determine at least one rule defining a predefined non-user event, said rule including at least one condition and an action item to be performed to automatically adjust said media player when said condition is satisfied;
analyze input information characterizing a non-user event to identify said condition; and
perform said action item if said condition is satisfied.

15. An article of manufacture for controlling a media player, comprising:
a computer readable medium having computer readable code means embodied thereon, said computer readable code means comprising:
a step to determine at least one rule defining a predefined non-user event, said rule including at least one condition and an action item to be performed to automatically adjust said media player when said condition is satisfied;
a step to analyze input information characterizing a non-user event to identify said condition; and
a step to perform said action item if said condition is satisfied.
